(19) United States
(12) Patent Application Publication
(10) Pub. No.: US 2011/0075874 A1
(43) Pub. Date: Mar. 31, 2011

(54) Waterproof Speakers and Audio System

(76) Inventor: Keith Richards, Lawndale, CA (US)

(21) Appl. No.: 12/883,099

(22) Filed: Sep. 15, 2010

Related U.S. Application Data
(60) Provisional application No. 61/246,986, filed on Sep. 30, 2009.

(51) Int. Cl. H04R 1/02

(52) U.S. Cl. 381/334

(57) ABSTRACT

The present invention is directed to a waterproof speaker and audio system that can be worn in one or more holding pockets in a wetsuit, neoprene collar, or other garment, the waterproof speaker and audio system has one or more components, a first component having one or more of the following: a transmitter unit, speaker, amplifier, digital audio file storage space (for example, MP3 or Windows Media Audio file), rechargeable battery, one or more buttons, one or more input and output ports such as a universal serial bus (USB) port for charging the battery and file transfer, one or more LED lights to indicate battery charge, a screen to provide audio file information including track number, and an FM and AM radio, and a second component designed to work in connection with the first component having one or more of the following: an amplifier, rechargeable battery, speaker, receiver, and one or more control buttons.

### CROSS-REFERENCES TO RELATED APPLICATIONS

This patent application claims the benefit of U.S. Provisional Patent Application Ser. No. 61/246,986 filed Sep. 18, 2009 for A Waterproof Speaker System (with built in rechargeable batteries and amplification) located on or near any part of the body, supported in a holding pocket for speakers and Digital Transmitter, which application is incorporated here by this reference.

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### TECHNICAL FIELD

This invention relates to a waterproof speaker and audio system with one or more of the following: a transmitter, speakers, digital file memory storage device, converter to convert audio files into sound, rechargeable batteries, volume amplification, input and output capability, signal receiver, the system capable of being mounted on or near any part of the body in one or more holding pockets in a wetsuit, neoprene collar, or other garment.

### BACKGROUND ART

Engaging in water sports that require a wetsuit or other specialty apparel can be fun and exciting, but can be tedious or unstimulating without some sort of sound such as one's favorite music, broadcast, or other audio output. Access to audio output can be technically impossible in the water, physically uncomfortable, or difficult to hear with existing water-resistant or waterproof devices.

Many audio players available on the market have significant technical difficulties such as structural deficiencies that prevent the player from being secured to a person or garment while in the water, a sound system that does not transmit sound loud enough or well enough to be heard by the user, little or no battery power, and confusing external controls that incorrectly display battery charge, volume, and track number, or non-existent external control functions that leave a user guessing when the device will run out of battery or has a charged battery, what track the device is playing, or the volume level.

Also, in trying to keep the device compact, many players utilize the same button for multiple tasks, including powering on and off resulting in inadvertent powering down when trying to change audio files or increase or decrease volume.

Other waterproof cases for audio players that are not water resistant have significant drawbacks, including the inability to be totally sealed to prevent water from seeping in and difficulty in hearing the audio output

There exists a need in the art to provide an audio player system that can be utilized in the water, attached to a user, with a stable battery life, the battery being easily rechargeable, and designed with components to ease using the system.

### DISCLOSURE OF INVENTION

The present invention is directed to a waterproof speaker and audio system that can be worn in one or more holding pockets in a wetsuit, neoprene collar, or other garment. The waterproof speaker and audio system has one or more components, each component having one or more speakers and designed to work in conjunction with the other components within the system.

In one embodiment, the present invention has a first and second components. The first component or “master” component has one or more of the following: a speaker, digital audio file storage device (for example, capable of storing MP3 or Windows Media Audio files), converter to convert audio files into sound, rechargeable battery, one or more buttons, including buttons for volume control, audio file selection, and broadcast channel selection, one or more input or output ports such as a universal serial bus (USB) port for charging the battery and file transfer and a plug such as a ⅛ plug to connect the unit by hardwire to head phones or to the second component or to a battery charger, one or more LED lights to indicate battery charge, a screen to provide audio file information including track number, transmitter, amplifier, FM and AM radio, and tsunami warning alert.

The input port may be capable of receiving USB input to charge the battery and file transfer. An input port may also be capable of receiving a plug such as a ⅛ plug. The output port may be a flip out USB output capable of being plugged into a computer for charging the battery and file transfer. In having one or more input or output ports, the first component may have different configurations; for example, the first component may have a USB flip out output port and an input port capable of receiving a plug, a USB input port and an input port capable of receiving a plug, a USB flip-out output port and USB input port, a USB flip out output port, a USB input port, or an input port capable of receiving a plug. The flip-out USB port is tucked into the first or second component when closed and may include a release button to release it and move it into the flipped-out, open position. When the USB port is in the flipped-out open position, it can be plugged into another electronic device.

The first component may optionally include one or more of the following: a mobile phone signal receiver and built in mobile phone, a wireless receiver for battery charging.

A second component designed to work in connection with the first component has one or more of the following: speaker, rechargeable battery, one or more buttons for volume control and volume control system, one or more LED lights to indicate volume level, receiver, amplifier, and input port capable of receiving a plug for example a plug such as a ⅛ plug to connect the unit by hardwire to head phones or to the first component or a plug to recharge the battery. To work in connection with each other, the first and second components may be capable of communicating wirelessly or via a wire adapter. The first component and second component may work wirelessly together to emit audio through the speakers or if a wire adapter is used, it can be inserted into the input ports of the first and second components and the wire can be discretely tucked into the apparel such as the wetsuit or collar used in connection with the inventive system.

The system is capable of being mounted on or near any part of the body in one or more holding pockets in a wetsuit, neoprene collar, or other garment. Preferably, the system is mounted in close proximity to a user's ears. In one embodiment, the system is capable of being mounted on the shoulders of a wetsuit. The shoulder mounts can be affixed to a wetsuit in a manner so that they are securely connected in wet environments. The inventive system can be inserted into the shoulder mounts and secured into the mount as a pressure fit or as a pocket with closure. Alternatively, the inventive system can be secured into a wetsuit manufactured with pocket inserts or it can be secured into other sports apparel in shoulder or arm pockets; for example, in biking, running, or walking apparel or in a life jacket, jacket, shirt, webbing, strapping, or netting top vest.

In yet another embodiment, the system is capable of being mounted in a neck collar with two or more pockets. In one embodiment, the collar has first and second pockets. The first and second pockets may be positioned on each side of the collar in parallel relation to each other in close proximity to the user's ears, just under the ears of a wearer. The collar is preferably made of neoprene or other waterproof material, floatable, and constructed with a reusable clasp that may release upon significant pressure in safety situations, including choking prevention. The clasp may be located in between the first and second pockets and may be positioned to be worn in the back of the neck or in the front. Additional pockets in the collar may be designed to carry electronic devices such as a cell phone or two-way radio, for example, a third pocket may carry the electronic device and may be positioned under a wearer's mouth to allow for an optimal position to capture the user's voice.

The inventive system is waterproof, meaning that it is capable of resisting water and capable of emitting audio and receiving and transmitting signals in wet environments. The system may resist water in various depths, for example, in depths up to 50 feet.

In another embodiment, the speakers in the one or more components can be in different configurations; for example, the first component may have one or more speakers and the second component may have one or more speakers.

The rechargeable battery in the first and second components can be recharged wirelessly or via the one or more input or output ports on the first component or the one or more input ports on the second component.

The speakers may be capable of different amperages in order to emit enough volume to be heard in wet, windy, dirty, and otherwise rough physical conditions. The inventive first and second components with speakers are worn close to the ear, but not in the ear thus creating a very safe environment for the user who is capable of hearing other noises when listening to the audio output. This allows the user to be aware of the environment, including approaching large waves, wildlife, seacraft, and other people. The waterproof feature of the first and second component is ideal for water use and sports use where one may be exercising and perspiring or exercising in rainy, wet conditions.

Also, mounting the first and second components on the shoulders or in a collar provides for waterproof hands free and hassle free listening.

In use, a digital signal can be transmitted to the first component via wire or wireless transmission, the first component can receive the signal with a receiver, amplify them with the amplifier and direct the sound out through the speaker pointed in the direction of the ear. The second component can receive the signal as well and amplify it, and direct the sound out through the speaker so that both components have sound coming out of the speakers.

The components of the system are of a size and shape that allows the waterproof speaker and audio system to be mounted on the shoulders or the neck of a user and still allow maximum mobility while engaging in sports related activities such as surfing, paddle boarding, biking, running, swimming, and the like. In one embodiment, the components are from 1.5 to 3 inches wide, 0.5 to 1.5 inches high, and 0.2 to 1.0 inch thick. In another embodiment, the components are about 2.5 inches wide, 1.0 inch high, and 0.5 inch thick.

### BRIEF DESCRIPTION OF DRAWINGS

FIG. 1 is a front view of one embodiment of the waterproof speaker and audio system having two components.

FIG. 2 is a perspective view of one embodiment of the waterproof speaker and audio system having two components as shown in FIG. 1.

FIG. 3 is a front view of one embodiment of the waterproof speaker and audio system having two components and having a flip-out USB port.

FIG. 4 is a perspective view of one embodiment of the waterproof speaker and audio system having two components and having a pop-out USB port as shown in FIG. 3.

FIG. 5 is a front view of the waterproof speaker and audio system in use mounted in two shoulder pockets in a wetsuit.

FIG. 6 is an expanded view of shoulder mounts for attaching the mounts to a wetsuit, the mounts capable of receiving the waterproof speaker and audio system.

FIG. 7 is a front view of a waterproof collar adapted to be used with the waterproof speaker and audio system.

FIG. 8 is a front view of the waterproof speaker and audio system in use mounted in two pockets in a collar as shown in FIG. 7.

### BEST MODE FOR CARRYING OUT THE INVENTION

The detailed description set forth below in connection with the appended drawings is intended as a description of presently-preferred embodiments of the invention and is not intended to represent the only forms in which the present invention may be constructed or utilized. The description sets forth the functions and the sequence of steps for constructing and operating the invention in connection with the illustrated embodiments. However, it is to be understood that the same or equivalent functions and sequences may be accomplished by different embodiments that are also intended to be encompassed within the spirit and scope of the invention.

FIG. 1 depicts a front view of one embodiment of the waterproof speaker and audio system having a first and second component. The first component 10 has one or more of the following: a speaker 12, digital audio file storage device (for example, capable of storing MP3 or Windows Media Audio files), converter to convert audio files into sound, and rechargeable battery (all of which are inside the component and not shown), a button 14, an input port capable of receiving a USB plug 16, an input port capable of receiving a plug, such plug for charging the battery, headphones, or connecting the first component 10 to the second component 100. The first component also has one or more indicator lights to indicate battery charge 20, a screen to provide audio file information including track number 22, and transmitter, amplifier, FM and AM radio, and tsunami warning alert (all of which are inside the component and not shown). The button 14 may be for volume control, audio file selection, and/or broadcast channel selection.

The first component may optionally include one or more of the following: a mobile phone signal receiver and built in mobile phone, a wireless receiver for battery charging.

A second component 100 designed to work in connection with the first component 10 is also shown. The second component 100 has one or more of the following: speaker 112, one or more buttons for volume control and volume control system, one of which is shown 114, one or more indicator lights to indicate volume level 116, receiver, amplifier, and rechargeable battery (all of which are inside the component and not shown), and one or more input ports 118 and 120 capable of receiving a plug. For example, a plug such as a ⅛ plug to connect the unit by hardwire to head phones or to the first component or a plug to recharge the battery or a USB key. The input port 120 may be located on the front of the second component 100 as shown or it may be on the side or back of the second component.

The indicator lights may be LED or any other light source that uses very little energy to emit light and can be used in a waterproof system.

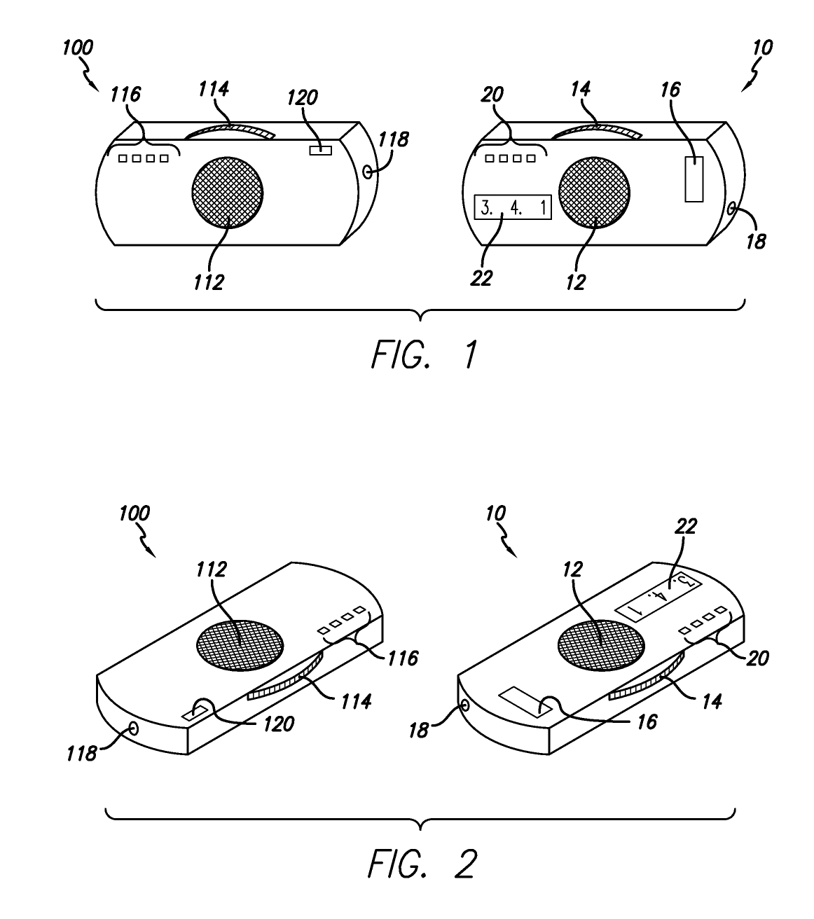

FIG. 2 provides a perspective view of one embodiment of the waterproof speaker and audio system having two components as shown in FIG. 1. The external elements of the first and second components (10 and 100, respectively) are shown. For example, the first component 10 has a speaker 12, screen 22, button 14, input and/or output ports 16 and 18, and indicator lights 20. The second component 100 has a speaker 112, button 114, input and/or output ports 118 and 120, and indicator lights 116.

FIG. 3 depicts a front view of one embodiment of the waterproof speaker and audio system having a first and second components, 200 and 300, respectively and having a flip-out USB port 216. As shown, the first component 200 has indicator lights 220, a flip-out USB port 216, an input port 218, a screen 222, and a speaker 212. It is understood that the first component 200 has internal elements not shown in order to make the component operable including a digital audio file storage device (for example, capable of storing MP3 or Windows Media Audio files), converter to convert audio files into sound, rechargeable battery, transmitter, amplifier, FM and AM radio, and tsunami warning alert. Also, the second component 300 of the waterproof speaker and audio system is shown. The second component 300 has a speaker 312, indicator lights 316, a control button 314, and one or more input or output ports 318 and 320. It is understood that the second component 300 has internal elements not shown in order to make the component operable including rechargeable battery, volume control system, receiver, and amplifier.

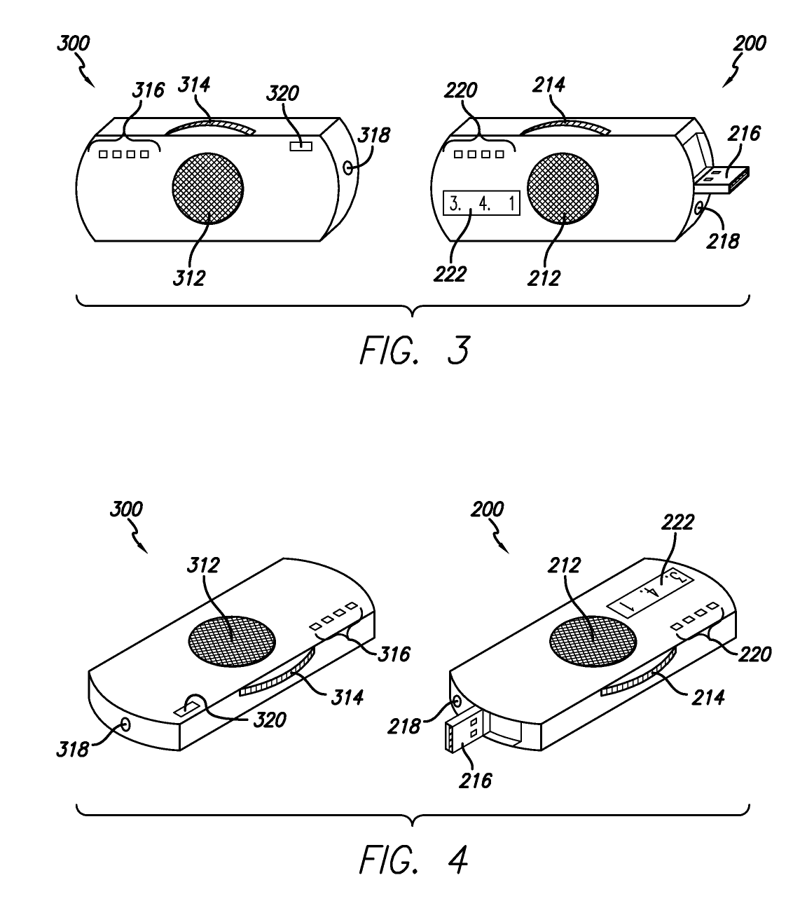

FIG. 4 depicts a perspective view of one embodiment of the waterproof speaker and audio system having first and second components 200 and 300, respectively and having a pop-out USB port 216 as shown in FIG. 3. As shown, the first component 200 has indicator lights 220, a flip-out USB port 216, an input port 218, a screen 222, and a speaker 212. It is understood that the first component 200 has internal elements not shown in order to make the component operable including but not limited to a digital audio file storage device (for example, capable of storing MP3 or Windows Media Audio files), converter to convert audio files into sound, rechargeable battery, transmitter, amplifier, FM and AM radio, and tsunami warning alert. Also, the second component 300 of the waterproof speaker and audio system is shown. The second component 300 has a speaker 312, indicator lights 316, a control button 314, and one or more input or output ports 318 and 320. It is understood that the second component 300 has internal elements not shown in order to make the component operable including but not limited to rechargeable battery, volume control system, receiver, and amplifier.

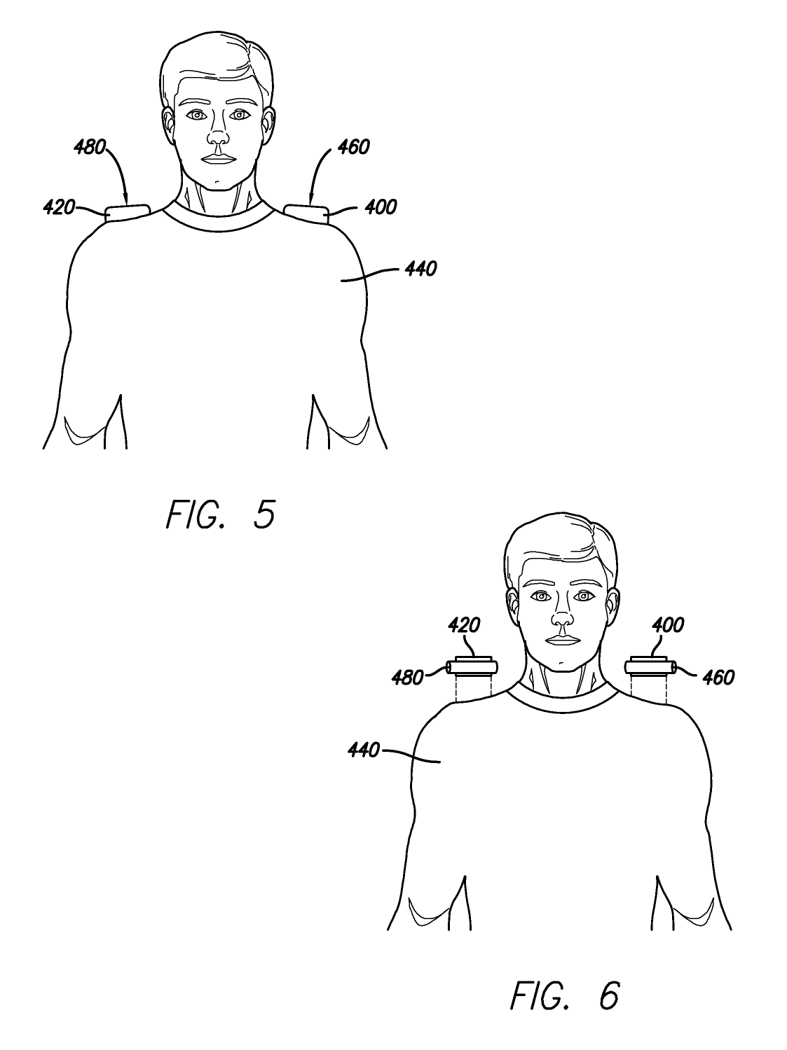

FIG. 5 depicts a front view of the waterproof speaker and audio system 460 and 480 in use mounted in two shoulder pockets 400 and 420 in a wetsuit 440. The may be mounted on or near any part of the body in one or more holding pockets in a wetsuit, neoprene collar, or other garment. Preferably, the system is mounted in close proximity to a user's ears. As shown, the system is capable of being mounted on the shoulders of a wetsuit 400. The shoulder mounts 400 and 420 can be affixed to a wetsuit 440 in a manner so that they are securely connected in wet environments. The inventive system 460 and 480 can be inserted into the shoulder mounts and secured into the mount as a pressure fit or as a pocket with closure. Alternatively, the inventive system can be secured into a wetsuit manufactured with pocket inserts or it can be secured into other sports apparel in shoulder or arm pockets; for example, in biking, running, or walking apparel or in a life jacket, jacket, shirt, webbing, strapping, or netting top vest.

FIG. 6 provides an expanded view of shoulder mounts 400 and 420 for attaching the mounts 400 and 420 to a wetsuit 440, the mounts capable of receiving the waterproof speaker and audio system 460 and 480. The mounts 400 and 420 can be sold as aftermarket, attachable pockets that a user can install onto his wetsuit 440. The mounts 400 and 420 can be attached by any means capable of securing them to a wetsuit 440 and staying secured in wet or rough environments. Alternatively, the mounts 400 and 420 can be attached when a wetsuit 440 is manufactured. The mounts 400 and 420 are of a size and shape capable of receiving the waterproof speaker and audio system 460 and 480. They may be designed with an opening on one side so that the speakers of the one or more inventive components are not covered. The opening may be of a shape and size capable of allowing audio to be transferred through.

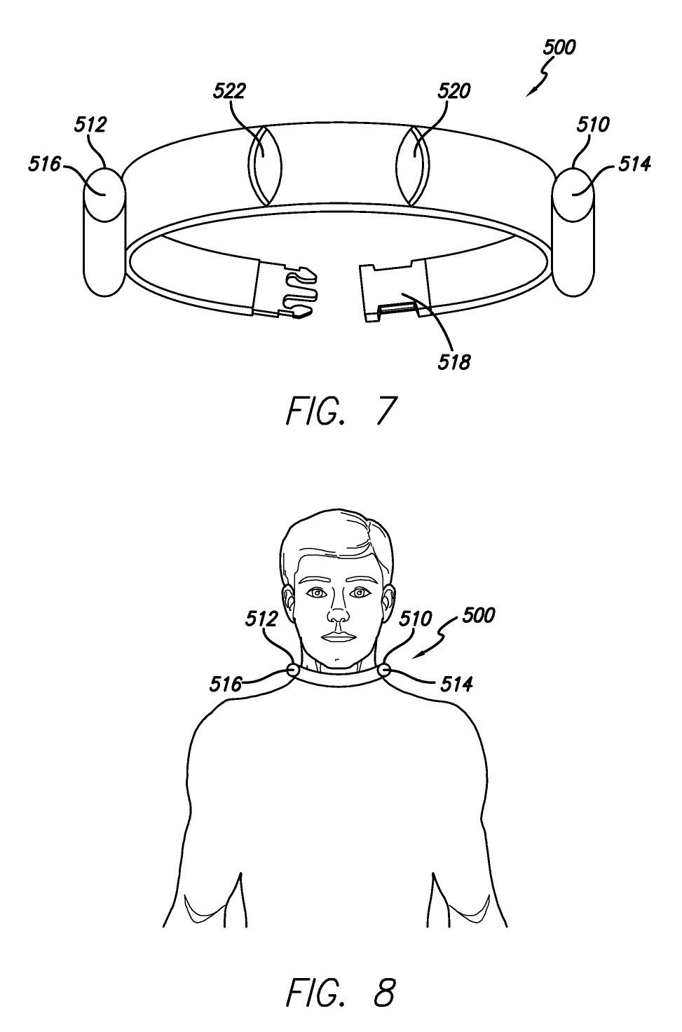

FIG. 7 depicts a front view of a waterproof collar 500 adapted to be used with the waterproof speaker and audio system 514 and 516. As shown, the collar has first and second pockets 510 and 512, respectively. The first and second pockets 510 and 512 may be positioned on each side of the collar 500 in parallel relation to each other in close proximity to the user's ears, just under the ears of a wearer. The collar is preferably made of neoprene or other waterproof material, floatable, and constructed with a reusable clasp 518 that may release upon significant pressure in safety situations, including choking prevention. The clasp may be located in between the first and second pockets 510 and 512 and may be positioned to be worn in the back of the neck or in the front. Additional pockets in the collar 520 and 522 may be designed to carry electronic devices such as a cell phone or two-way radio, for example, a third pocket may carry the electronic device and may be positioned under a wearer's mouth to allow for an optimal position to capture the user's voice.

FIG. 8 shows a front view of the waterproof speaker and audio system 514 and 516 in use mounted in two pockets 510 and 512 in a collar 500 as shown in FIG. 7.

While the present invention has been described with regards to particular embodiments, it is recognized that additional variations of the present invention may be devised without departing from the inventive concept.

### INDUSTRIAL APPLICABILITY

This invention may be industrially applied to the development, manufacture, and use of a waterproof speaker and audio system.

What is claimed is:

1. A waterproof speaker and audio system comprising
a first component having one or more speakers, a digital audio file storage device, a converter to convert audio files into sound, a rechargeable battery, one or more buttons, one or more input ports, one or more output ports, one or more LED lights to indicate battery charge, a screen to provide audio file information including track number, a transmitter, an amplifier, and a FM and AM radio,
a second component for working in connection with the first component having one or more speakers, a rechargeable battery, one or more buttons, a receiver, an amplifier, and one or more input ports,
wherein the first component and second component work together to emit audio through the speakers.

2. The waterproof speaker and audio system of claim 1 wherein the first component and second component work together wirelessly to emit audio through the speakers.

3. The waterproof speaker and audio system of claim 1 having one output port in the first component wherein the output port is a universal serial bus.

4. The waterproof speaker and audio system of claim 1 having one input port in the first component wherein the input port is a ⅛ plug.

5. The waterproof speaker and audio system of claim 1, having one input port in the first component wherein the input port is a universal serial bus port.

6. The waterproof speaker and audio system of claim 1, wherein the output port in the first component is a universal serial bus port.

7. The waterproof speaker and audio system of claim 1, wherein the first component further comprises a tsunami warning alert.

8. The waterproof speaker and audio system of claim 3, wherein the universal serial bus port flips out.

9. The waterproof speaker and audio system of claim 1, wherein the system is capable of resisting water in depths up to 50 feet.

10. The waterproof speaker and audio system of claim 1, wherein the second component has one button for volume control.

11. The waterproof speaker and audio system of claim 1, wherein the input port in the second component is capable of receiving a plug to connect the second component to the first component.

12. The waterproof speaker and audio system of claim 1, wherein the input port in the second component is capable of receiving a plug to recharge the battery.

13. A waterproof speaker and audio system comprising
a first component having one or more speakers, a digital audio file storage device, a converter to convert audio files into sound, a rechargeable battery, one or more buttons, one or more input ports, one or more output ports, one or more LED lights to indicate battery charge, a screen to provide audio file information including track number, a transmitter, an amplifier, and a FM and AM radio,
a second component that works in connection with the first component, the second component having one or more speakers, a rechargeable battery, one or more buttons, a receiver, an amplifier, and one or more input ports,
first and second shoulder holders, the first shoulder holder for holding the first component and the second shoulder holder for holding the second component,
wherein the first component and second component work together to emit audio through the speakers.

14. The waterproof speaker and audio system of claim 13, wherein the first and second shoulder holders are made of neoprene.

15. The waterproof speaker and audio system of claim 13, wherein the first and second shoulder holders have an adhesive side for affixing the holders to the shoulders of a wetsuit.

16. A waterproof speaker and audio system comprising
a first component having one or more speakers, a digital audio file storage device, a converter to convert audio files into sound, a rechargeable battery, one or more buttons, one or more input ports, one or more output ports, one or more LED lights to indicate battery charge, a screen to provide audio file information including track number, a transmitter, an amplifier, and a FM and AM radio,
a second component that works in connection with the first component, the second component having one or more speakers, a rechargeable battery, one or more buttons, a receiver, an amplifier, and one or more input ports,
first and second shoulder holders, the first shoulder holder for holding the first component and the second shoulder holder for holding the second component, and
a collar with first and second pockets, the first pocket for holding the first component and the second pocket for holding the second component, the collar being made of neoprene and having a releasable clasp,
wherein the collar can be worn about a user's neck so that the first and second components are in close proximity to the user's ears.

17. The waterproof speaker and audio system of claim 16 wherein the collar has a third pocket capable of holding an electronic device.

18. The waterproof speaker and audio system of claim 16 wherein the collar is made of neoprene.

19. The waterproof speaker and audio system of claim 16 wherein the collar has a releasable clasp.

20. The waterproof speaker and audio system of claim 16 wherein the first and second pockets are in parallel relation in close proximity to the user's ears and the clasp is located in between the first and second pockets.
